(19) United States
(12) Patent Application Publication
(10) Pub. No.: US 2018/0191990 A1
(43) Pub. Date: Jul. 5, 2018

(54) PROJECTION SYSTEM

(71) Applicant: BANDAI NAMCO ENTERTAINMENT INC., Tokyo (JP)

(72) Inventors: Hirofumi MOTOYAMA, Yokohama-shi (JP); Motonaga ISHII, Saitama-shi (JP)

(73) Assignee: BANDAI NAMCO ENTERTAINMENT INC., Tokyo (JP)

(21) Appl. No.: 15/909,836

(22) Filed: Mar. 1, 2018

Related U.S. Application Data
(63) Continuation of application No. PCT/JP2016/075841, filed on Sep. 2, 2016.

(30) Foreign Application Priority Data
Sep. 2, 2015 (JP) 2015-172568

(51) Int. Cl. H04N 5/74; G03B 21/14

(52) U.S. Cl. CPC H04N 5/74; G03B 21/14

(57) ABSTRACT

A projection system includes a projector projecting a projection image, and a processor acquiring position information on at least one of first and second targets based on detection information obtained by a sensor, and performing a process of generating the projection image. The processor performs, when the first target and the second target are determined to have satisfied given relationship based on the position information acquired, a process of changing a content of at least one of a first projection image to be projected onto the first target and a second projection image to be projected onto the second target.

### CROSS REFERENCE TO RELATED APPLICATION

This application is a continuation of International Patent Application No. PCT/JP2016/075841, having an international filing date of Sep. 2, 2016, which designated the United States, the entirety of which is incorporated herein by reference. Japanese Patent Application No. 2015-172568 filed on Sep. 2, 2015 is also incorporated herein by reference in its entirety.

### BACKGROUND

The present invention relates to a projection system and the like.

Conventionally known systems project a projection image onto a projection target with a projection device. JP-A-2013-192189 and JP-A-2003-85586 disclose techniques related to such conventional projection systems.

The projection systems according to the conventional techniques described in JP-A-2013-192189 and JP-A-2003-85586 only simply project an image, generated by an image generation device, onto a projection target, and thus lack user interaction. Specifically, the conventional projection systems use a projection image not reflecting a result of moving a projection target by a user. Thus, the systems do not offer an entertaining element of enabling the user to move the projection target in an interactive manner. For example, an attraction facility employing a projection system has not enabled the user to recognize a display object, in the projection image, as if it is an object in the real world. Thus, it has not been able to provide an attraction or the like that can be enjoyed for a long period of time without getting bored.

In this context, user interaction may be achieved with an image following a projection target. Still, no method of employing relative positional relationship between targets for enabling an image to move among a plurality of targets has been proposed.

### SUMMARY

According to one aspect of the invention, there is provided a projection system comprising:

a projector projecting a projection image; and

a processor acquiring position information on at least one of first and second targets based on detection information obtained by a sensor, and performing a process of generating the projection image,

the processor performing, when the first target and the second target are determined to have satisfied given relationship based on the position information acquired, a process of changing a content of at least one of a first projection image to be projected onto the first target and a second projection image to be projected onto the second target, and

the processor obtaining positional relationship between the second target and a virtual plane set to be at a given position relative to the first target to determine whether or not the first target and the second target have satisfied the given relationship.

According to another aspect of the invention, there is provided projection system comprising:

a projector projecting a projection image onto a play field serving as a first target: and

a processor performing a process of generating the projection image,

the processor generating the projection image for displaying an image of a water surface onto a virtual plane set to be at a given position relative to the play field and for displaying an image of a creature,

the projector projecting the projection image for displaying the image of the water surface and the image of the creature onto the play field,

the processor performing, based on position information on a second target, a process of changing a content of at least one of a first projection image to be projected onto the play field serving as the first target and a second projection image to be projected onto the second target.

### BRIEF DESCRIPTION OF THE DRAWINGS

FIG. 1 is a diagram illustrating an example of an overall configuration of a projection system according to an embodiment.

FIG. 2 is a diagram illustrating a specific example of the configuration of the projection system according to the embodiment.

FIG. 3A and FIG. 3B are diagrams illustrating a method of projecting a projection image onto a target.

FIG. 4 is a diagram illustrating a method according the embodiment.

FIG. 5 is a diagram illustrating an example of a height information map.

FIG. 6A and FIG. 6B are diagrams illustrating a method of changing a content of a projection image projected onto a target.

FIG. 7A and FIG. 7B are diagrams illustrating a method of acquiring position information and the like with a marker set to a target.

FIG. 8 is a diagram illustrating a method of changing a display object based on a marker pattern.

FIG. 9A and FIG. 9B are diagrams illustrating a method of projecting a projection image onto a container.

FIG. 10 is a diagram illustrating a method of acquiring position information using a bait item and the like.

FIG. 11 is a diagram illustrating a method of generating a projection image projected onto a target.

FIG. 12 is a diagram illustrating a modification of the present embodiment.

FIG. 13 is a diagram illustrating a process of correcting a projection image.

FIG. 14 is a flowchart illustrating an example of a process according to the embodiment in detail.

FIG. 15 is a flowchart illustrating an example of a process according to the embodiment in detail.

FIG. 16 is a flowchart illustrating an example of a process according to the embodiment in detail.

### DESCRIPTION OF EXEMPLARY EMBODIMENTS

Some aspects of the present invention can provide a projection system and the like solving the problem described above with a projection image, reflecting information on positional relation between targets and the like, projected while offering more active user interaction.

According to one embodiment of the invention, there is provided a projection system comprising:

a projector projecting a projection image; and

a processor acquiring position information on at least one of first and second targets based on detection information obtained by a sensor, and performing a process of generating the projection image,

the processor performing, when the first target and the second target are determined to have satisfied given relationship based on the position information acquired, a process of changing a content of at least one of a first projection image to be projected onto the first target and a second projection image to be projected onto the second target, and

the processor obtaining positional relationship between the second target and a virtual plane set to be at a given position relative to the first target to determine whether or not the first target and the second target have satisfied the given relationship.

According to one aspect of the present invention, the position information on at least one of the first and the second targets is acquired based on the detection information obtained by the sensor section. Then, when the first and the second targets are determined to have satisfied the given relationship based on the position information acquired, the process of changing the content of at least one of the first and the second projection images to be projected onto the first and the second targets. With this configuration, the content of the first projection image and/or the second projection image can be changed by determining the relationship between the first and the second targets based on the position information on the targets. Thus, a projection image reflecting information on the positional relationship between the targets and the like can be projected to enable more active user interaction.

And with this configuration, whether or not the first and the second targets have satisfied the given relationship can be determined by obtaining positional relationship between the second target and the virtual plane set to be at the given position relative to the first target, instead of obtaining the positional relationship between the first and the second targets. Thus, various processes can be performed while making a user feel as if the virtual plane is an actual surface (such as a water surface), for example.

In the projection system,

the processor may perform, when the first target and the second target are determined to have satisfied the given relationship, at least one of a process of making a display object appear, a process of making a display object disappear, and a process of changing an image of a display object in at least one of the first projection image to be projected onto the first target and the second projection image to be projected onto the second target.

With this configuration, the user can feel as if the display object has appeared or disappeared or the image has changed as a result of the first and the second targets satisfying the given relationship. Thus, the projection system offering more active user interaction can be achieved.

In the projection system,

the processor may perform a process of generating, when the first target and the second target are determined to have satisfied the given relationship, the second projection image in such a manner that a display object serving as a projection target to be projected onto the first target is projected onto the second target.

With this configuration, the display object serving as the projection target to be projected onto the first target can be projected and displayed to follow the second target for example, when the first and the second targets satisfy the given relationship. Thus, a projection image showing the display object appearing at a location corresponding to the second target as a result of the first and the second targets satisfying the given relationship can be generated.

In the projection system,

the processor may perform display control on the display object based on relationship between the display object to be projected onto the second target and the second target.

With this configuration, when the display object is projected onto the second target with the first and the second targets satisfying the given relationship, various types of display control are performed on the display object based on the relationship between the display object and the second target, whereby a wide variety of projection images can be generated.

In the projection system,

the processor may perform, when the first target and the second target have satisfied the given relationship, a calculation process based on a process rule, and may perform display control on the display object in such a manner that the display object determined to be projected onto the second target as a result of the calculation process is projected onto the second target.

With this configuration, the calculation process based on a process rule is performed when the first and the second targets satisfy the given relationship. Then, the projection image is generated with various types of display control on the display object performed in such a manner that the display object determined to be projected onto the second target is displayed onto the second target based on a result of the calculation process.

In the projection system,

the processor may perform, when relationship between the first target and the second target changes from the given relationship, display control on the display object in accordance with change in the relationship between the first target and the second target.

With this configuration, when the relationship between the first and the second targets changes from the given relationship, the display control is performed on the display object in accordance with the change in the relationship, and a projection image reflecting the change in the relationship is generated.

In the projection system,

the processor may perform, when the relationship between the first target and the second target changes, a calculation process based on a process rule and may perform display control on the display object in such a manner that the display object determined to be projected onto the second target as a result of the calculation process is projected onto the second target.

With this configuration, the calculation process based on a process rule is performed when the relationship between the first and the second targets changes, and the projection image is generated with the display control on the display object performed in such a manner that the display object determined to be projected onto the second target is projected onto the second target, based on a result of the calculation process.

In the projection system,

the processor may perform, when the relationship between the first target and the second target changes, a calculation process based on a process rule and may perform display control on the display object in such a manner that the display object determined not to be projected onto the second target as a result of the calculation process is projected onto the first target.

With this configuration, the calculation process based on a process rule is performed when the relationship between the first and the second targets changes, and the projection image is generated with the display control on the display object performed in such a manner that the display object determined not to be projected onto the second target is projected onto the first target, based on a result of the calculation process.

In the projection system,

the processor may perform, when the second target and a third target are determined to have satisfied given relationship, a process of displaying the display object onto the third target.

With this configuration, the projection image can be generated to simulate movement of the display object projected onto the second target from the second target to the third target, for example.

In the projection system,

the processor may obtain relative positional relationship between the first target and the second target based on the detection information obtained by the sensor to determine whether or not the first target and the second target have satisfied the given relationship.

With this configuration, the projection image reflecting the positional relationship between the first and the second targets can be generated, whereby more active user interaction and the like can be offered.

In the projection system,

the relative positional relationship may be relationship between the first target and the second target in height.

With this configuration, the projection image reflecting the relationship in height between the first and the second targets can be generated.

In the projection system,

the processor may perform a recognition process on a marker set to the second target based on the detection information obtained by the sensor, may acquire position information on the second target based on a result of the recognition process, and may determine whether or not the first target and the second target have satisfied the given relationship based on the position information acquired.

With the marker thus used, the relationship between the first and the second targets can be determined with the position information on the second target stably and appropriately acquired.

In the projection system,

the processor may obtain, based on the marker, a second projection area onto which the second projection image is projected and may perform a process of generating the second projection image to be projected onto the second projection area.

With this configuration, the marker is used to obtain the second projection area, to generate the second projection image to be projected onto the second projection area and to implement the process of changing the content of the second projection image, for example.

In the projection system,

the second target may be a body part of a user or a held object held by the user.

With this configuration, the projection image interactively reflecting the behaviors of the body part of the user or the held object can be generated.

According to another embodiment of the invention, there is provided a projection system comprising:

a projector projecting a projection image onto a play field serving as a first target: and

a processor performing a process of generating the projection image,

the processor generating the projection image for displaying an image of a water surface onto a virtual plane set to be at a given position relative to the play field and for displaying an image of a creature,

the projector projecting the projection image for displaying the image of the water surface and the image of the creature onto the play field,

the processor performing, based on position information on a second target, a process of changing a content of at least one of a first projection image to be projected onto the play field serving as the first target and a second projection image to be projected onto the second target.

According to an aspect of the present invention, the projection image for displaying the image of the water surface onto the virtual plane set to be at the given position relative to the play field and for displaying the image of the creature is projected onto the play field. The content of at least one of the first projection image to be projected onto the play field and the second projection image to be projected onto the second target changes in accordance with the position information on the second target. With this configuration, the projection system showing the water surface at the position of the play field corresponding to the virtual plane and the creature around the water surface can be implemented, for example. Furthermore, the content of the first and the second projection images can be changed in accordance with the position information on the second target, whereby the projection system offering more active user interaction can be implemented.

In the projection system,

the processor may perform at least one of a process of making a display object appear, a process of making a display object disappear, and a process of changing an image of a display object in at least one of the first projection image to be projected onto the play field and the second projection image to be projected onto the second target.

With this configuration, the user can feel as if the display object has appeared or disappeared or the image of the display object has changed, whereby the projection system offers more active user interaction.

In the projection system,

the processor may perform a recognition process for a marker set to the second target, may acquire position information on the second target based on a result of the recognition process, and may perform a process of changing a content of at least one of the first projection image and the second projection image based on the position information acquired.

With the marker thus used, the content of at least one of the first projection image and the second projection image can be changed with the position information on the second target stably and appropriately acquired.

In the projection system,

the processor may perform, when the second target and the play field serving as the first target are determined to have satisfied given relationship based on the position information on the second target, a process of changing a content of at least one of the first projection image and the second projection image.

With this configuration, the content of at least one of the first and the second projection images is changed when the first and the second targets satisfy the given relationship, whereby the projection system offers more active user interaction.

In the projection system,

the processor may acquire the position information on the second target based on the detection information obtained by the sensor.

With this configuration the content of the at least one of the first and the second projection images can be changed by acquiring the position information on the second target by using the sensor.

In the projection system,

the projector may project the projection image for displaying the image of the water surface and the image of the creature onto the play field by projection mapping.

With this configuration, the projection mapping is employed so that the projection image can be projected onto the play field with various shapes, while being less affected by the shapes.

In the projection system,

the play field may be a sand pit.

With this configuration, the projection system can simulate the water surface and creatures on the sand pit.

In the projection system,

the processor may generate the projection image for displaying animation of the water surface and the creature.

With this configuration, the waves or the like on the water surface and a movement of creatures can be displayed in animation to be realistically simulated.

In the projection system,

the projector system may be provided above the play field.

With this configuration, the projector can project the projection image onto the play field while being installed at an inconspicuous location above the play field.

An exemplary embodiment of the invention is described below. Note that the following exemplary embodiment do not in any way limit the scope of the invention defined by the claims laid out herein. Note also that all of the elements described in connection with the following exemplary embodiments should not necessarily be taken as essential elements of the invention.

1. Configuration of Projection System

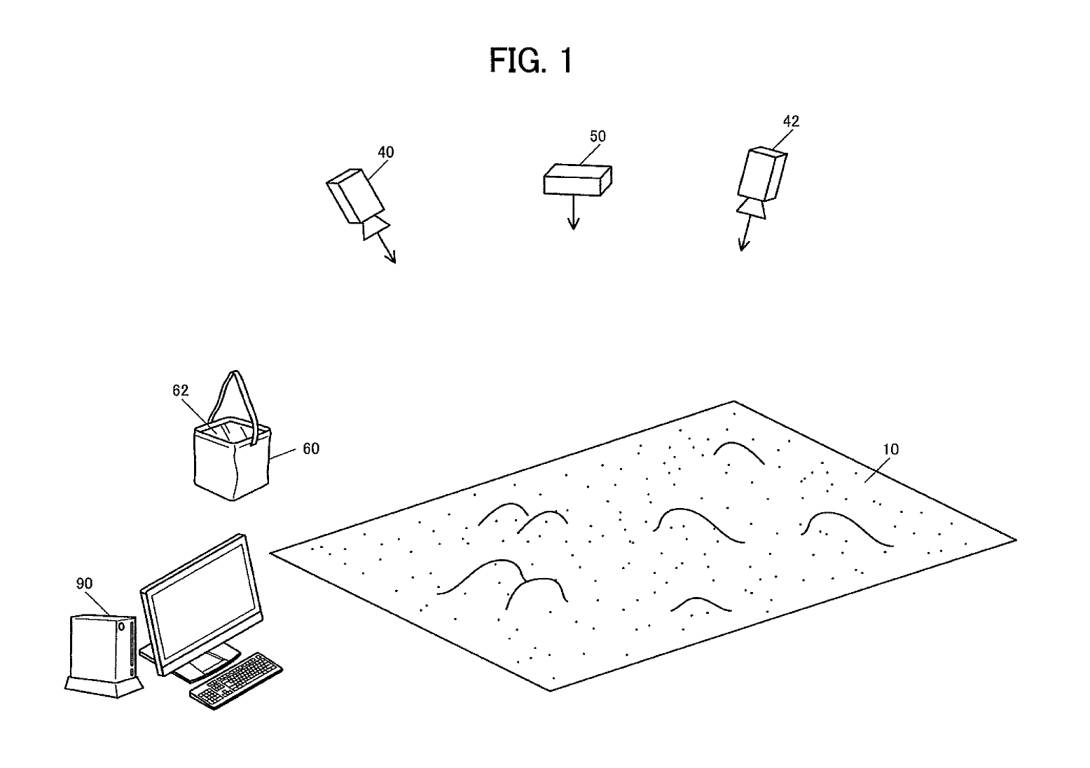

FIG. 1 illustrates an example of an overall configuration of a projection system according to the present embodiment. The projection system according to the present embodiment includes projection sections 40 and 42 and a processing device 90 (a projection section in a broad sense). The projection system may further include a sensor section 50. The configuration of the projection system according to the present embodiment is not limited that illustrated in FIG. 1, and various modifications may be made by partially omitting the components (sections) of the projection system, or by adding other components.

A play field 10 is a field where a user (player) enjoys attractions or the like, and is illustrated as a sand pit filled with sand in FIG. 1. For example, the play field 10 may also be various other fields including: a field with flowers and grass; a dirt ground filed; a field for playing sports; and a field serving as a course of a racing game or the like.

The projection sections 40 and 42 project projection images onto the play field 10 (a first target in a broad sense) and the like, and can be implemented with projectors. In FIG. 1, the projection sections 40 and 42 are provided above the play field 10 (on a ceiling or the like for example), and project the projection images onto the play field 10 below the projection sections 40 and 42 from above. In FIG. 1, the two projection sections 40 and 42 are provided. Note that the number of projection sections may be one or may be equal to or larger than three. If the play field 10 involves no topographical change, what is known as a rear projection system may be employed with a floor surface serving as a screen and a projector (projection section) provided below the floor surface, or the floor surface may be formed as a flat panel display such as a liquid crystal display (LCD).

The sensor section 50 detects position information on a target and the like. In FIG. 1, the sensor section 50 is provided above the play field 10 (on the ceiling or the like for example), and detects the position information on a target, in the play field 10. An example of the position information includes height information (height information on each area). For example, the sensor section 50 can be implemented with a normal camera that captures an image, a depth sensor (distance sensor), or the like.

As described later, a bucket 60 is for storing a creature such as fish that has been caught, and has an upper surface provided with a display section 62 (a display of a tablet PC for example). The display section 62 displays a display object representing the caught creature.

The processing device 90 functions as a processing section according to the present embodiment, and performs various processes such as a process of generating a projection image. For example, the processing device 90 can be implemented with various information processing devices such as a desktop PC, a laptop PC, and a tablet PC.

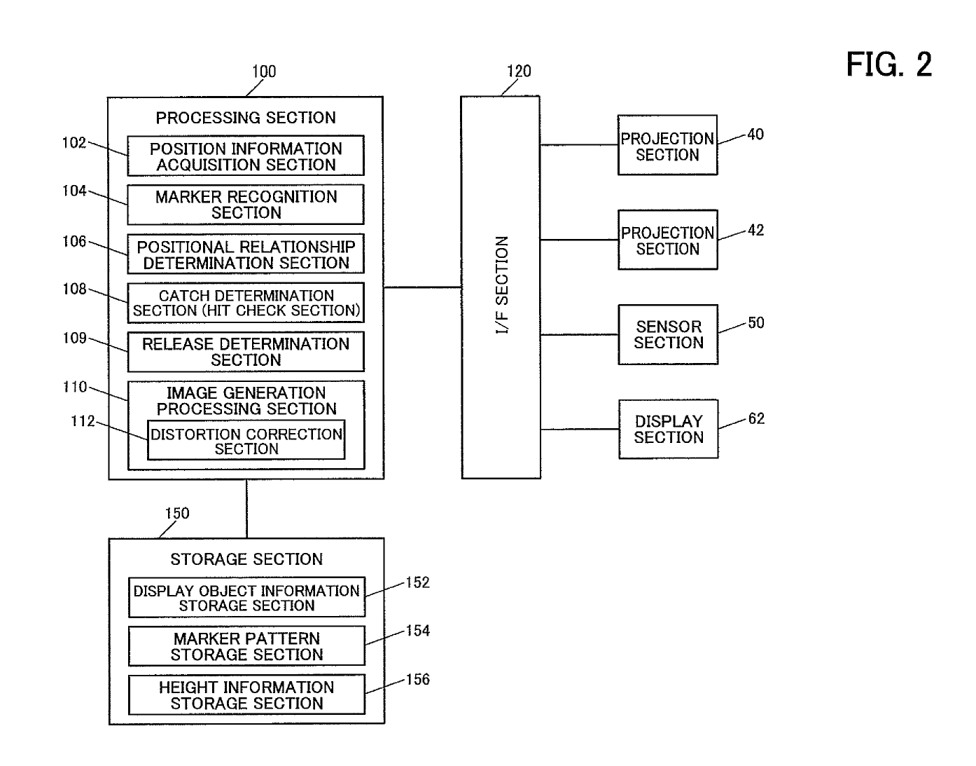

FIG. 2 illustrates a detailed configuration example of the projection system according to the present embodiment. For example, the processing device 90 illustrated in FIG. 1 is implemented with a processing section 100, an interface (I/F) section 120, a storage section 150, and the like in FIG. 2.

The processing section 100 (processor) performs various determination processes, an image generation process, and the like based on detection information from the sensor section 50 and the like. The processing section 100 uses the storage section 150 as a work area to perform various processes. The function of the processing section 100 can be implemented with a processor (a central processing unit (CPU), a graphics processing unit (GPU), and the like), hardware such as an application specific integrated circuit (ASIC) (such as a gate array), and a program of various types.

The I/F section 120 is for performing an interface process for external devices. For example, the I/F section 120 performs the interface process for the projection sections 40 and 42, the sensor section 50, and the display section 62. For example, information on a projection image generated by the processing section 100 is output to the projection sections 40 and 42 through the I/F section 120. The detection information from the sensor section 50 is input to the processing section 100 through the I/F section 120. Information on an image to be displayed on the display section 62 is output to the display section 62 through the I/F section 120.

The storage section 150 serves as a work area for the processing section 100, and has a function that can be implemented with a random access memory (RAM), a solid state drive (SSD), a hard disk drive (HDD), or the like. The storage section 150 includes a display object information storage section 152 that stores information (such as image information) on a display object, a marker pattern storage section 154 that stores information on a marker pattern, and a height information storage section 156 that stores height information (position information) on a target.

The processing section 100 includes a position information acquisition section 102, a marker recognition section 104, positional relationship determination section 106, a catch determination section 108, a release determination section 109, and an image generation processing section 110. The image generation processing section 110 includes a distortion correction section 112. Note that various modifications may be made by partially omitting these components (sections) or by adding other components.

In the present embodiment, the processing section 100 acquires position information on at least one of first and second targets, based on the detection information from the sensor section 50. For example, the position information acquisition section 102 performs a process of acquiring position information (for example height information) on a target, based on the detection information from the sensor section 50. For example, position information on at least one of the first target and the second target is acquired as described later. The first target includes the play field 10. The second target includes a body part of a user, a container, or the like. For example, the position information (height information) on the first target (such as the play field 10) may be stored as an information table in the storage section 150 in advance. In such a configuration, the position information (height information) may not be obtained based on the detection information from the sensor section 50. The same applies to the position information on the second target.

The processing section 100 performs a process of generating a projection image. The projection image thus generated is projected by the projection sections 40 and 42. For example, the image generation processing section 110 performs a process of generating a projection image by providing a predetermined creature at a deep position in the field, and not displaying water at a position where the field is raised to be determined to be higher than a virtual water surface (virtual plane). Such a position is rendered as a ground instead. When a plurality of projectors (projection sections 40 and 42) are used as in FIG. 1, a seam between images provided by the projectors is preferably made inconspicuous. Thus, a distance between the projector and each pixel corresponding to the seam needs to be obtained accurately as much as possible. The height information described above can be used for such a purpose. In this process, the distortion correction section 112 may perform a distortion correction process for the projection image. For example, the distortion correction process is performed to reduce distortion involved in the projection of the projection image onto a target, based on the position information on the target or the like. The distortion correction process also depends on a viewpoint position of an observer. Thus, it might be unpreferable to perform the distortion correction when the viewpoint position of the observer is difficult to obtain or when there are a plurality of observers. Whether or not the distortion correction is performed may be determined as appropriate based on a detail of a content of a projection image or a status of the observer.

Specifically, the processing section 100 determines whether or not the first target and the second target have satisfied given relationship, based on the position information acquired based on the detection information from the sensor section 50. The determination process is performed by the positional relationship determination section 106. When the first and the second targets are determined to have satisfied the given relationship, a process is performed to change the content of at least one of first and second projection images respectively projected onto the first and the second targets. For example, a process of changing the content of one or both of the first and the second projection images is performed. The image generation processing section 110 performs this image changing process. Then, the first and the second projection images, after the changing process, are projected onto the first and the second targets by the projection sections 40 and 42, respectively.

For example, the first target is the play field 10 illustrated in FIG. 1 or the like. For example, the second target is a body part of the user, a held object held by the user, or the like. For example, the body part of the user is a hand (palm) of the user, and the held object held by the user is an object that can be held by the user. Such an object includes a container held by a user's hand or the like. A part of the user may also be a part including the face, the chest, the stomach, the waist, a foot, or the like of the user. The held object may be an object other than the container, or may be an object held by a body part of the user other than the hand. The first target is not limited to the play field 10, and may be any target that can be a projection target of a main image or the like, such as a background. Similarly, the second target is not limited to the body part of the user and the held object.

The processing section 100 obtains positional relationship between the second target and a virtual surface (virtual plane) at a given position (height) relative to the first target, and determines whether or not the first target and the second target have satisfied the given relationship. Then, the processing section 100 changes the content of at least one of the first and the second projection images, respectively projected onto the first and the second targets.

For example, the virtual plane corresponding to a projection surface is set at a position (upper position) offset from the projection surface of the first target. For example, this virtual plane is virtually set as a plane corresponding to the projection surface of the play field 10. Whether or not the second target and the virtual plane, instead of the first target (the projection surface of the first target), have satisfied the given relationship (positional relationship) is determined. For example, whether or not the second target (the body part of the user or the held object) and the virtual plane (for example a virtual sea surface or a virtual water surface) have satisfied the given relationship is determined. Specifically, whether or not the second target is below the virtual plane or the like is determined. When the given relationship has been satisfied, a process is performed to change the second projection image (an image on the hand or the container for example) projected onto the second target or the first projection image (for example an image of a creature or a sea surface) projected onto the first target.

When the first target and the second target are determined to have satisfied the given relationship (given positional relationship in a narrow sense), the processing section 100 performs at least one of processes including: a process of making a display object appear in at least one of the first projection image projected onto the first target and the second projection image projected onto the second target; a process of making the display object disappear; and a process of changing an image of the display object. For example, the processing section 100 performs a process including: a process of making a display object, such as a creature described later, appear in the first projection image or the second projection image; a process of making the display object disappear; or a process of changing an image (display pattern, texture, color, effect, or the like) of the display object. Thus, a process of changing the content of at least one of the first projection image projected onto the first target and the second projection image projected onto the second target is implemented when the first target and the second target are determined to have satisfied the given relationship. Information on the display object (image information, object information, attribute information, and the like) is stored in the display object information storage section 152.

For example, when the first target and the second target are determined to have satisfied the given relationship, the processing section 100 performs a process of generating the second projection image in such a manner that a display object that is a projection target to be projected onto the first target is projected onto the second target (to be projected to follow the second target). For example, a display object such as a sea creature serves as a projection target to be projected onto the play field 10 serving as the first target. In the present embodiment, when the first target such as the play field 10 and the second target that is a body part of the user such as a hand of the user or the held object held by the user have satisfied the given relationship, a process of generating a projection image is performed in such a manner that the display object such as a sea creature is displayed while taking not only the first target but also the position, the shape, and the like of the second target such as the body part of the user or the held object into consideration.

For example, when the first target and the second target are determined to have satisfied the given relationship, the processing section 100 determines whether or not the display object that is the projection target projected onto the first target is caught by the second target. The catching determination section 108 (hit check section) performs this process. The processing section 100 (image generation processing section 110) performs the process of generating the second projection image in such a manner that the display object, determined to have been caught, is projected onto the second target. For example, when the display object such as a sea creature is caught by the second target such as the hand, the container, or the like, the display object such as the caught creature is projected onto the second target.

The processing section 100 performs a process of generating the first projection image in such a manner that the display object that is determined not to be caught is displayed onto the first target. For example, when a display object such as a sea creature is not caught by the second target, the displayed object that has been failed to be caught is projected onto the first target such as the play field 10.

The processing section 100 performs display control on a display object based on relationship between the display object projected onto the second target and the second target.

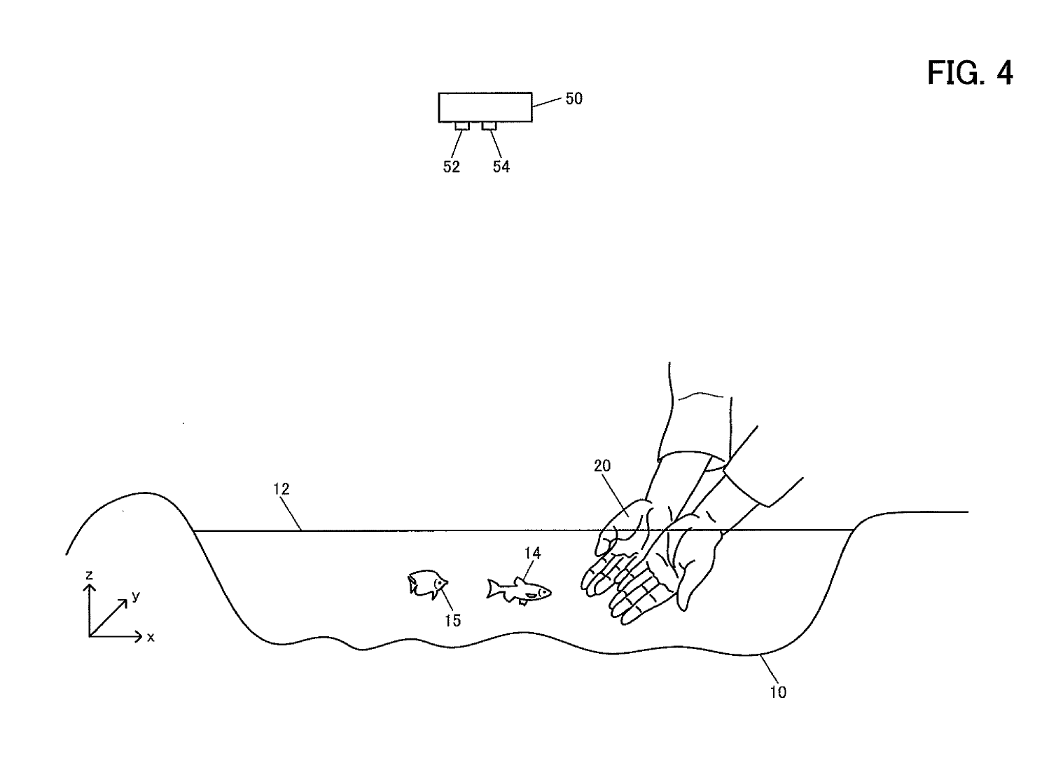

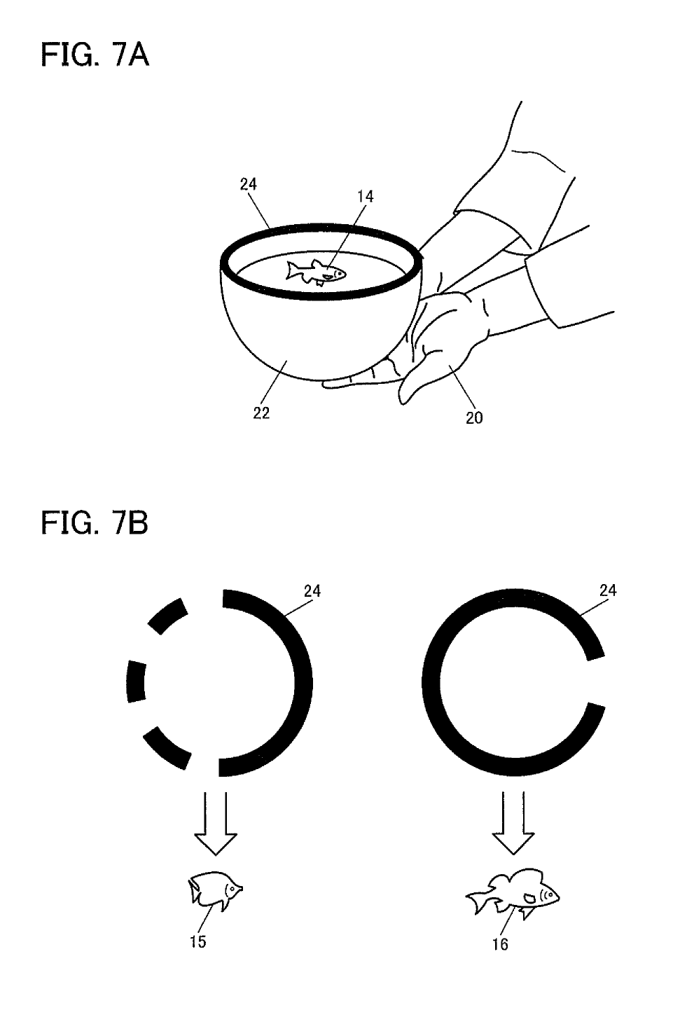

For example, when fish 14 is determined to be caught by hands 20 that are a body part of the user or a container 22 that is the held object as illustrated in FIG. 4 or FIG. 7A described later, the fish 14 as the display object is displayed in the hands 20 or the container 22 serving as the second target. For example, when the hands 20 or the container 22 serving as the second target, moved downward through a virtual sea surface 12 as described in FIG. 4 as described later, and the play field 10 serving as the first target are determined to have satisfied the given relationship, a process of projecting the fish 14 onto the hands 20 or the container 22 is performed.

In this case, the processing section 100 performs display control to express actions of the fish 14 that is the display object including nudging the hands 20, bumping into an edge of the container 22, and the like. For example, a hit check process is performed to check hitting between the fish 14 and the hands 20/container 22. Then, display control is performed to control the movement of the fish 14 based on a result of the hit check process. Thus, the player can experience virtual reality simulating the living fish 14 moving on the hands 20 or swimming in the container 22.

The processing section 100 performs a calculation process based on a process rule when the first target and the second target have satisfied the given relationship, and then performs display control on a display object in such a manner that the display object determined to be projected onto the second target as a result of the calculation process is projected onto the second target.

For example, the calculation process based on the process rule is performed, when the play field 10 serving as the first target and the hands 20 or the container 22 serving as the second target are determined to have satisfied the given relationship (for example, when the hands 20 or the container 22 are determined to be below the virtual sea surface 12). For example, fish within a predetermined range (predetermined radius) from the hands 20 or the container 22 (serving as the center position) is searched for. The calculation process (game process) is performed in such a manner that the fish is attracted toward the hands 20 or the container 22. This calculation process is based on a predetermined process rule (algorithm). Possible examples of the calculation process include a search process, a movement control process, a hit check process, and the like, based on a predetermined algorithm (program). For fish determined to be projected onto the hands 20 or the container 22 serving as the second target as a result of the calculation process, display control is performed in such a manner that the fish that is the display object is projected onto the hands 20 or the container 22. For example, the display control is performed to move the fish toward the hands 20 or the container 22.

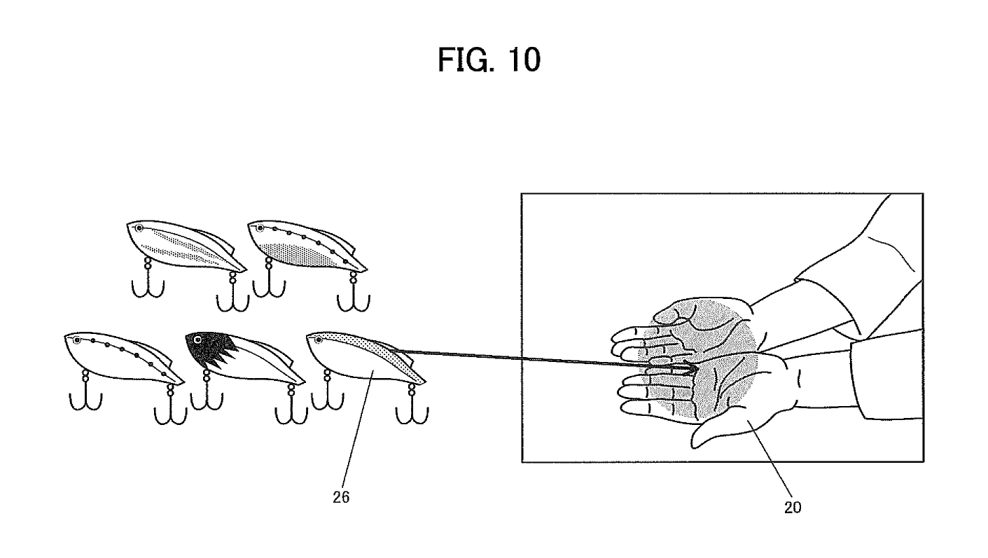

This calculation process based on a process rule includes various processes. For example, when a bait item 26 is on the palms of the hands 20 as illustrated in FIG. 10 described later, a calculation process is performed in such a manner that more fish are attracted toward the hands 20. On the other hand, when there is no bait item 26, a calculation process is performed in such a manner that no fish or less fish is attracted toward the hands 20. Thus, the display control can be performed for a display object base on a result of a calculation process that is a process similar to that in games.

When the relationship between the first target and the second target changes from the given relationship, the processing section 100 performs display control on a display object in accordance with the change in the relationship between the first target and the second target.

For example, as illustrated in FIG. 4 described later, the hands 20 may be raised so that the given relationship satisfied with the hands 20 being below the virtual sea surface 12 (virtual water surface) changes to relationship where the hands 20 are raised to be above the virtual sea surface 12. In such a case, the processing section 100 performs display control on the display object such as fish in accordance with the change in the relationship (the change as a result of the hand moving upward through the virtual sea surface 12). For example, when such a change in the relationship occurs, it is determined that the fish has been caught, and thus, display control is performed to express a state where the fish is caught with the hands 20. For example, display control is performed in such a manner that the fish is displayed (projected) on the hands 20. Alternatively, display control is performed in such a manner that the fish above the hands 20 jumps or glitters. Examples of the display control on the display object include a process of moving a display object, a process of changing a behavior (motion) of the display object, and a process of changing a property of the display object including an image color, brightness, and texture.

Specifically, when the relationship between the first target and the second target changes, the processing section 100 performs a calculation process based on a process rule. Then, the processing section 100 performs display control on a display object in such a manner that the display object determined to be projected onto the second target as a result of the calculation process is projected onto the second target. For example, the processing section 100 performs display control in such a manner that the fish is expressed to be caught with the hands 20 of the user. Alternatively, the processing section 100 performs display control on a display object in such a manner that a display object determined not to be projected onto the second target as a result of the calculation process is projected onto the first target. For example, display control is performed in such a manner that fish failed to be caught escapes to the play field 10 serving as the first target.

For example, the change in relationship might occur with the hands 20 or the container 22 moving to be above the virtual sea surface 12. In such a case, display control is performed in such a manner that the fish that has been in a portion around the center of the hands 20 or the container 22 stay above the hands 20 or inside the container 22. Furthermore, display control is performed in such a manner that fish that has been at a tip of the hands 20 or at an edge of the container 22 escapes to the play field 10 from the hands 20 or the container 22. For example, a calculation process (calculation process based on a process rule) is performed to determine whether or not the fish is within a predetermined range (predetermined radius) from the center position (reference position) of the hands 20 or the container 22. When the fish is within the predetermined range, display control such as movement control on fish is performed in such a manner that the fish is projected onto the hands 20 or the container 22. When the fish is outside the predetermined range, the display control such as movement control on fish is performed in such a manner that the fish escapes from the hands 20 or the container 22 to be projected onto the play field 10. With such display control on a display object based on the calculation process, a game process of capturing fish with the hands 20 or the container 22 can be implemented, whereby a novel projection system can be achieved.

When the second target and a third target are determined to have satisfied given relationship (given positional relationship in a narrow sense), the processing section 100 performs a process of displaying the display object on the third target (a process of displaying the display object in a location of the third target). The process of displaying a display object on the third object includes a process of displaying the display object on a display section (for example, the display section 62 in FIG. 1) of the third target, and a process of projecting the display object onto the third target.

For example, when the second target and the third target have satisfied the given relationship, the display object (the caught display object) is determined to be released to the location of the third target. This determination process is performed by the release determination section 109. Then, a process of displaying the released display object on the third target (a process of displaying the display object on the location of the third target) is performed. For example, a display object such as a sea creature may be caught with the second target such as the hands and the container, and then the second target and the third target such as the bucket 60 in FIG. 1 may satisfy the given positional relationship. For example, positional relationship may be satisfied with the second target such as the hands of the user or the container placed close to the third target such as the bucket 60. In such a case, the processing section 100 (release determination section 109) determines that the caught creature or the like has been released. Then, the processing section 100 (image generation processing section 110) generates an image including the caught creature or the like, as a display image to be displayed on the display section 62 of the bucket 60. Thus, an image simulating a state where the caught creature or the like is released to move into the bucket 60 is generated. In this case, a process of projecting the display object such as a caught creature onto the third target such as the bucket 60 may be performed.

The processing section 100 obtains relative positional relationship between the first target and the second target based on the detection information from the sensor section 50, to determine whether or not the first target and the second target have satisfied the given relationship. For example, the relative positional relationship in a height direction or a horizontal direction is obtained. Then, when the given relationship is determined to have been satisfied, the content of at least one of the first and the second projection images is changed.

The relative positional relationship is relationship between the first target and the second target regarding the height for example. For example, the relative positional relationship between the first and the second targets in the height direction is obtained based on the detection information from the sensor section 50. For example, whether the second target is above or below the first target or the virtual plane, set for the first target, is determined. Then, the content of at least one of the first and the second projection images respectively projected onto the first and the second targets based on the determination result is changed.

The processing section 100 performs a recognition process for a marker set to the second target based on the detection information from the sensor section 50. Then, the position information on the second target is acquired based on a result of the recognition process. Whether or not the first target and the second target have satisfied the given relationship is determined based on the acquired position information. For example, an image of the marker set to the second target is captured by the sensor section 50, whereby a captured image is acquired. Then, an image recognition process is performed on the captured image to acquire the position information on the second target. This series of marker recognition process is performed by the marker recognition section 104.

Specifically, the marker is provided and set to the second target. For example, when the second target is a body part of the user, the marker is attached to the body part of the user or an object serving as the marker is held by the body part of the user. When the second target is a held object held by the user, the held object itself may serve as the marker (with a feature amount of the color, the shape, or the like), or the marker is attached to the held object. Then, the marker is recognized by the sensor section 50, and the position information on the second target is acquired based on the recognition result. For example, the image recognition is performed for the marker in the captured image. Then, the position information (such as height information) on the marker is obtained based on the result of the image recognition. Thus, whether or not the first and the second targets have satisfied the given relationship is determined.

For example, the processing section 100 obtains a second projection area onto which the second projection image is projected, based on the marker, and then performs the process of generating the second projection image to be projected onto the second projection area. For example, a position (address) of the second projection area, on a video random access memory (VRAM) for example, is obtained based on a result of the recognition process for the marker, and the process of generating the second projection image in the second projection area is performed. Then, for example, a process of changing the content of the second projection image or the like is performed.

The processing section 100 generates a projection image for displaying an image of a water surface onto the virtual plane set to be at a given position relative to the play field serving as the first target and for displaying an image of a creature. For example, the creature may be displayed below, above, or on the virtual plane. The projection sections 40 and 42 project projection images, for displaying the image of the water surface and the image of the creature, onto the play field. In this case, the processing section 100 performs a process of changing the content of at least one of the first projection image to be projected onto the play field and the second projection image to be projected onto the second target, based on the position information on the second target. For example, a process of changing the content of one of the first and the second projection images or both is performed. Then, the projection sections 40 and 42 respectively project the first and the second projection images, after the change process, onto the first and the second targets.

The processing section 100 performs at least one of processes including: a process of making the display object appear in the image of at least one of the first projection image projected onto the play field and the second projection image projected onto the second target; a process of making the display object disappear; and a process of changing an image of the display object. Thus, the display object appears/disappears or the image of the display object is changed, in accordance with the position information on the second target (for example, a body part of the user or the held object).

The processing section 100 performs a recognition process for the marker set to the second target and acquires the position information on the second target based on a result of the recognition process. Then, a process of changing the content of at least one of the first projection image and the second projection image is performed based on the acquired position information. In this manner, the content of the first projection image and/or the second projection image can be changed by acquiring the position information on the second target by using the marker set to the second target.

Preferably, the processing section 100 changes the content of at least one of the first projection image and the second projection image when the play field and the second target are determined to have satisfied the given relationship based on the position information on the second target. Preferably, the processing section 100 acquires the position information on the second target based on the detection information from the sensor section 50.

The projection sections 40 and 42 project projection images, for displaying the image of the water surface and the image of the creature, onto the play field by projection mapping. For example, the projection image after the distortion correction or the like is projected. In this case, the play field is a sand pit for example, as described later. The processing section 100 generates a projection image with which the water surface and the creature are displayed as animation. Thus, an image showing a creature moving in real time under the water surface can be displayed. The projection sections 40 and 42 are provided above the play field for example. Thus, the projection images for displaying the water surface and the creature can be projected onto the play field from above.

2. Method According to the Present Embodiment

2.1 Overview of Attraction

First of all, an overview of an attraction implemented by a method according to the present embodiment is described. In the present embodiment, the play field 10 as illustrated in FIG. 1 is set up in an attraction facility. The play field 10 is a sand pit where children can play in the sand.

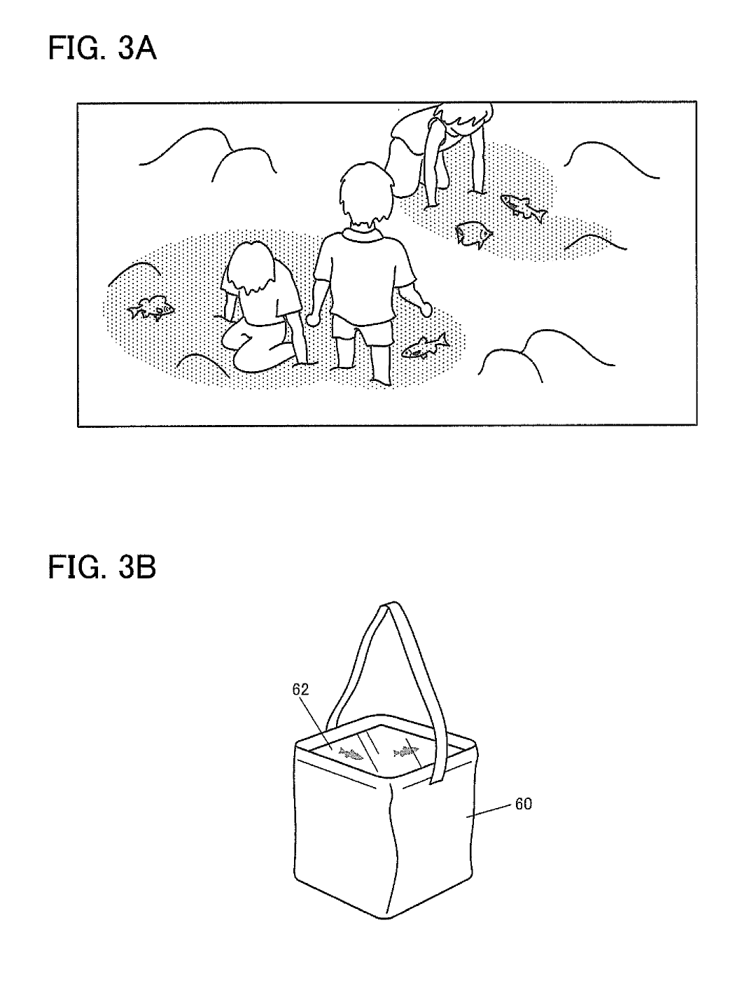

Images for displaying sea water, a sea creature, and the like are projected onto the play field 10 that is the sand pit as illustrated in FIG. 3A, by projection mapping using the projection sections 40 and 42. A child scoops up and catches a virtual creature with the palms of his or her hand. Then, when the hands that have caught the creature move to the location of the bucket 60 as illustrated in FIG. 3B, the caught creature is displayed on the display section 62. For example, the bucket 60 has an upper portion provided with a tablet PC having the display section 62 that displays the caught creature.

The attraction implemented with the method according to the present embodiment is not limited to the attraction illustrated in FIG. 1. For example, the method can be applied to an attraction based on a field other than that with a sand pit and the sea, and may be applied to an attraction implementing an entertainment element other than capturing sea creatures. The method according to the present embodiment is not limited to a large-scale attraction as illustrated in FIG. 1, and may be applied to an arcade game system including a play field for example.

With the attraction implemented by the method according to the present embodiment, parents can virtually experience the fun of play around a beach with their children, without having to worry about the safety or the like of their children, or to make a long trip to play by the beach. Children can catch small sea creatures with their hands without having to quit capturing the creatures as in the actual sea where these creatures swim so fast. Furthermore, the attraction virtually enables the users to easily yet sufficiently have fun playing around the beach by picking up sea shells and playing with restless waves.

To achieve this, the attraction according to the present embodiment is implemented by preparing the play field 10 that is an indoor sand pit people can easily visit. The attraction simulates the sounds of waves and birds singing to realistically simulate an actual tropical beach. The sea surface of a shallow beach with restless waves is realistically simulated with projection mapping performed on the sand. For example, the field sometimes has the water surface entirely projected thereon to simulate the full tide, or has a sand flat projected thereon to simulate drawing tides. Furthermore, interactive effects such as splashes and ripples are provided when a child's foot touches the water surface. Puddles are simulated at portions of the tidal flat appearing when the tide is out, based on the height information on the sand pit detected by the sensor section 50. The puddles are also simulated at a portion of the sand pit dug by a child. Images are projected by the projection system to simulate sea creatures swimming in the water or crawling on the sand. Children can enjoy scooping up and capturing these creatures with the palms of their hands.

The animation of the sea water and the caught creature is displayed on the scooping palms by projection mapping. The child can put the caught creature into the bucket 60 and observe the creature. The caught creature can be transferred to a smartphone to be taken home. Specifically, the caught creature can be displayed on a display section of the display section 62 of the bucket 60 or the smartphone, so that children can virtually feel that he or she has actually caught the creature. In this context, for example, when there is a creature that becomes friendly with a player, the player can call the creature next time he or she arrives at the attraction facility. Then, the attraction provides a communication event with such a creature. Specifically, the creature swims around or follows the player, or makes the other like actions.

The attraction according to the present embodiment described above projects an image onto the play field 10, which is a sand pit, by projection mapping and enables children to catch sea creatures. For example, an announcement such as “Kids! Work with your parents to catch fish as much as you can within a time limit” is issued. When a player throws in a glowing ball or the like, serving as a bait, fish is attracted to the bait. Then, the parents can scare fish to a certain area where the children can catch the fish. A visual effect of ripple waves on the beach is provided, and many shells and fish are displayed in an area where the tides are out. The children can use rakes and shovels to dig the sand to search for a treasure buried in the sand.

The attraction involves a large stage change. For example, when the tide is high in a regular state, the water surface, where the fish randomly swims, is displayed over a majority of the area of the sand pit.

Then, the tide changes to a low tide, making the sea floor (sand) appear with large and small tide pools remaining in recessed portions. Fish that has been in such a portion during the high tide is trapped in the portion when the tides are out, to be easily caught by children. Furthermore, creatures such as hermit crabs, crabs, and mantis shrimps, which are absent during the high tide, appear on the sand.

Then, a big wave brings a bonus stage. For example, the sand pit is entirely exposed to the big wave with a fast tidal current, bringing large fish or making treasures, rare sea shells, and the like appear on the sand washed away by the wave.

2.2 Method of Projecting Projection Image onto Target

To implement the attraction described above and the like, position information on at least one of the first and the second targets is acquired based on detection information from the sensor 50. Then, it is determined whether or not the first and the second targets have satisfied the given relationship, based on the acquired position information. When it is determined that the given relationship has been satisfied, the content of at least one of the first projection image projected onto the first target and the second projection image projected onto the second target is changed. For example, when a first projection surface corresponding to the first target and a second projection surface corresponding to the second target are in given relationship, the content of the first projection image to be projected onto the first projection surface or the second projection image to be projected onto the second projection surface is changed.

Specifically, as illustrated in FIG. 4, a projection image, for displaying the virtual sea surface 12 of a virtual sea shore as well as the fish 14 and fish 15, is projected onto the play field 10. Then, when a user (such as a child) moves the hands 20 downward through the virtual sea surface 12 (a virtual plane in a broad sense) displayed by projection mapping, the fish 14 and the fish 15 are attracted to the hands 20. In this process, for example, the fish 14 and the fish 15 may be attracted to a bait item, with a marker, on the hands 20 of the user moved downward through the virtual sea surface 12.

The user may raise the hands 20 to be at or above the height of the virtual sea surface 12 (to be at a predetermined threshold or higher), with the fish thus attracted. In this process, fish within a predetermined range from the hands 20 (or the bait item) is determined to be “caught”, and other fish is determined to have “escaped”. Then, an image of the fish determined to be caught is projected onto the hands 20 (the second target in a broad sense) of the user. For the fish determined to have escaped, an image showing the fish escaping into the sea is projected onto the play field 10 (the first target in a broad sense). For the predetermined range used for determining whether or not the fish is caught, color information may be set as a determination criterion, in such a manner that an effective area is set to be around the center of a range with the color of the hands.

After capturing the fish, the user may move the hands 20 toward the location of the bucket 60 (a location recognizable with an image marker or the like for example). Then, when the hands 20 (second target) and the bucket 60 (third target in a broad sense) satisfy given positional relationship, the fish is determined to have moved to the bucket 60. For example, this determination can be made by determining whether or not a given range set to the position of the bucket 60 overlaps with a given range set to the position of the hands 20. Then, when the fish is determined to have moved to the bucket 60, an image of the fish is displayed on the display section 62 (a display of a tablet PC) of the bucket 60 (bucket item). Thus, a visual effect of the caught fish moving into the bucket 60 can be provided.

Next, an example of a specific process for implementing the method according to the present embodiment is further described. In an example described below, the first target is the play field 10 and the second target is the hands of the user. However, the present embodiment is not limited to this. The first target may be an object other than the play field 10, and the second target may be a body part of the user other than the hand or may be the held object (such as a container) held by the user.

For example, the sensor section 50 in FIG. 4 includes a normal camera 52 (image capturing section) that captures a color image (RGB image) and a depth sensor 54 (distance measurement sensor) that detects depth information. The depth sensor 54 may employ Time Of Flight (TOF) and thus obtain the depth information from a time required for infrared light, projected onto and reflected from a target, to return. For example, the depth sensor 54 with such a configuration may be implemented with an infrared light projector that projects infrared light after pulse modulation and an infrared camera that detects the infrared light that has been reflected back from the target. Furthermore, light coding may be employed to obtain the depth information by reading an infrared pattern projected and obtaining distortion of the pattern. The depth sensor 54 with this configuration may be implemented with the infrared light projector that projects infrared light and the infrared camera that reads the projected pattern.

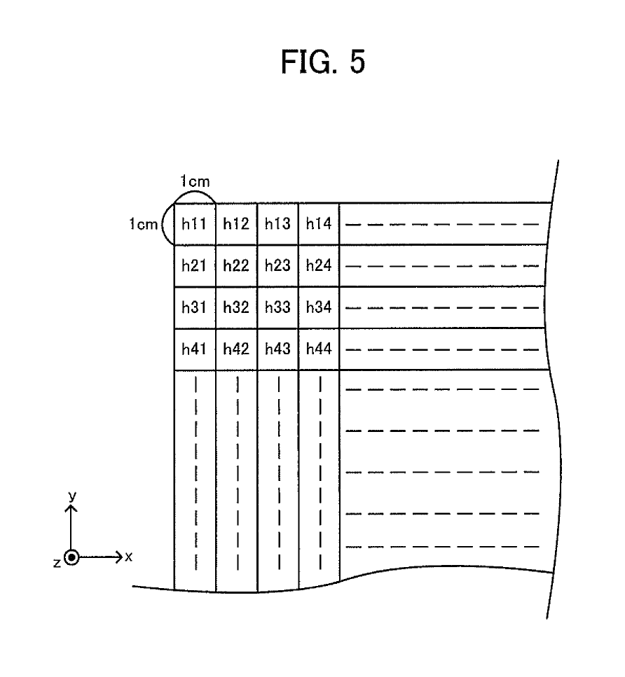

In the present embodiment, the sensor section 50 (depth sensor 54) is used to detect height information on the play field 10 or the like. Specifically, as illustrated in FIG. 5, pieces of height information h11, h12, h13, . . . in segments (for example 1 cm×1 cm segments) are acquired as a height information map (depth information map) based on the detection information (depth information) from the sensor section 50. The height information thus acquired is stored as the height information map in the height information storage section 156 in FIG. 2.

For example, in FIG. 4, a plane in plan view as viewed from the sensor section 50 is referred to as an XY plane, defined by X and Y axes, and an axis orthogonal to the XY plane is referred to as a Z axis. The XY plane is a plane in parallel with the first projection surface corresponding to the play field 10 (the plane represents an average value of the field that actually has unevenness). The Z axis is an axis extending along an oriented direction of the sensor section 50 (depth sensor 54). Under this condition, the height information in FIG. 5 is height information (depth information) in a Z axis direction, that is, height information in the Z axis direction based on the position of the play field 10 (first projection surface, first target) for example. In FIG. 4, the Z axis direction is a direction from the play field 10 toward the sensor section 50 above the play field 10 (upward direction in the figure). The height information map in FIG. 5 includes the pieces of height information h11, h12, h13 . . . corresponding to the segments in the XY plane.

The depth information detected by the depth sensor 54 of the sensor section 50 may be information on a linear distance between the position of the depth sensor 54 and each point (each segment). In such a case, the height map information in FIG. 5 can be obtained with the distance information converted into the height information in the Z axis direction described above.

Then, when the hands 20 are positioned above the play field 10 as illustrated in FIG. 4, the height information on the hands 20 (the second target in a broad sense) is stored in the segment corresponding to the position of the hands 20 in the height information map in FIG. 5. Thus, with the height information map illustrated in FIG. 5, not only the height information at each location of the play field 10 but also the height information on the hands 20 can be acquired.

In the present embodiment, the projection image is generated and projected onto the play field 10 and the like, based on the height information (depth information). For example, a projection image, for displaying the sea water and the sea creature, is generated and projected onto the play field 10 and the like. Thus, for example, the images of the sea water and the sea creature can be projected only onto the recessed portions of the sand as described above. For example, when the user digs the sand, an image of a puddle and the fish 14 and the fish 15 swimming in the puddle can be generated for the dug portion as illustrated in FIG. 4.

The projection image is generated with a process that is similar to that for generating a normal three-dimensional image (virtual three-dimensional image). For example, a process of setting objects, corresponding to the fish 14 and the fish 15, to be arranged in a physical space is performed. A physical space arrangement setting process is performed so that an image of the sea surface is displayed at the virtual sea surface 12 set to be at a given height from the projection surface of the play field 10. Then, an image in the physical space as viewed from a given viewpoint is generated as a projection image. This “given viewpoint” is preferably set to simulate the viewpoint of the user focusing on the area as much as possible. However, this is difficult when there are many users. Thus, the image may be set to be rendered as an image for parallel projection from directly above, as a most representative viewpoint.

With this configuration, various processes can be performed with the user virtually recognizing the virtual sea surface 12 as the sea surface that actually exists. For example, a virtual three-dimensional image showing the fish 14 and the fish 15 swimming under the sea surface the image of which is displayed at the position of the virtual sea surface 12, can be generated as the projection image.

In the present embodiment, the height information (the height in the Z axis direction) on the hands 20 can be detected based on the detection information (depth information) from the sensor section 50 (depth sensor 54). Thus, in the height information map in FIG. 5 described above, the height information on the hands 20 is stored in a segment corresponding to the position (the position in the XY plane) of the hands 20. For example, this position of the hands 20 can be identified by detecting an area with a color of the hands 20 (a color closer to the skin color than that in other areas) from a color image captured with the camera 52 of the sensor section 50. Alternatively, the position may be identified through a recognition process for a marker set to the position of the hands 20 as described later.

Then, whether or not the height of the hands 20 is lower than the height (the height in the Z axis direction) of the virtual sea surface 12 (virtual plane) is determined. When the height of the hands 20 is lower than the virtual sea surface 12, the hands 20 are determined to be in the water, and the sea water image is projected onto the palms of the hands 20. When hands 20 are under water, an image showing the fish 14 and the fish 15 moving toward the hands 20 is generated.

When the user raises the hands 20 with fish positioned in the palms of the hands 20 to a position higher than the virtual sea surface 12, whether or not the fish is caught is determined. Specifically, when the hands 20 are determined to be pulled out from the water, whether or not the fish is caught is determined. More specifically, fish within an area (an area in the XY plane) of a predetermined range from the position (position in the XY plane) of the hands 20 at this timing is determined to be caught. Fish outside the area of the predetermined range is determined to have been failed to be caught, that is, determined to have escaped.

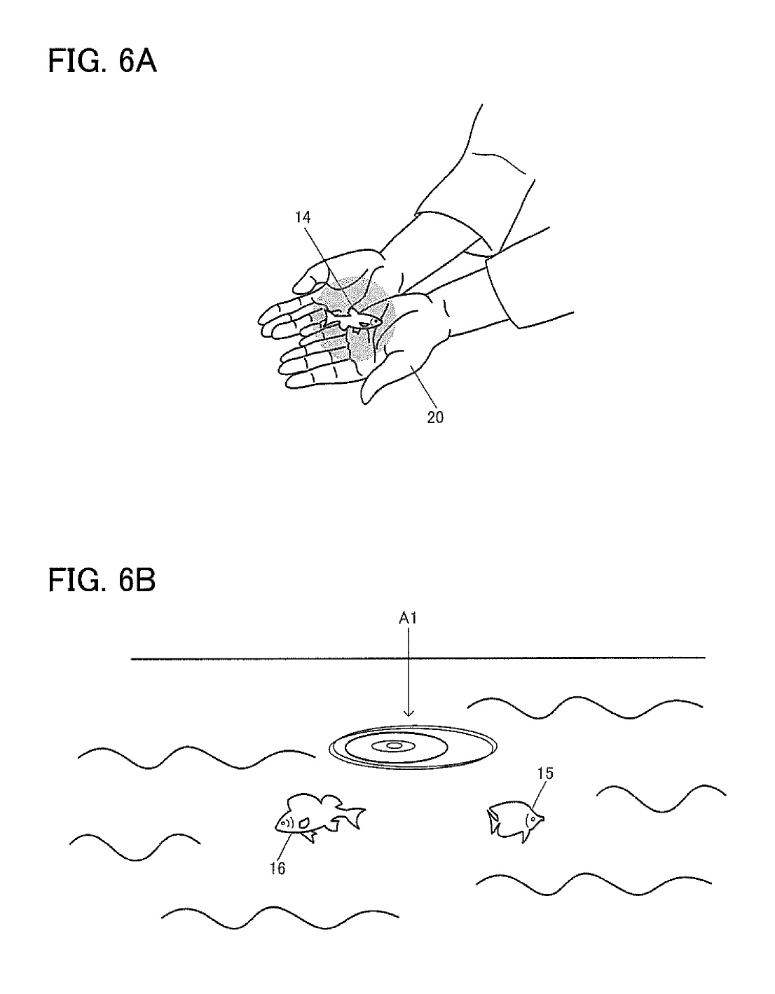

For example, in FIG. 6A, the fish 14 is determined to be caught. In such a case, images of the fish 14 and the sea water are projected onto the palms of the hands 20 that have been determined to be pulled out from the water. Thus, the user can experience virtual reality as if he or she has actually caught the fish 14 with his or her hands 20.

When the position of the hands 20 moves due to the user under this condition moving or moving the hands 20 only, an image showing the fish 14 following the movement of the hands 20 is generated. Thus, an image of the fish 14 staying within the hands 20 that have moved out from the water can be generated. For example, when the position of the hands 20 moves upward, the distance between the projection section 40 (42) in FIG. 1 and the hands 20 decreases. Thus, the fish 14 appears to get smaller as the hands 20 move upward unless a correction is performed.

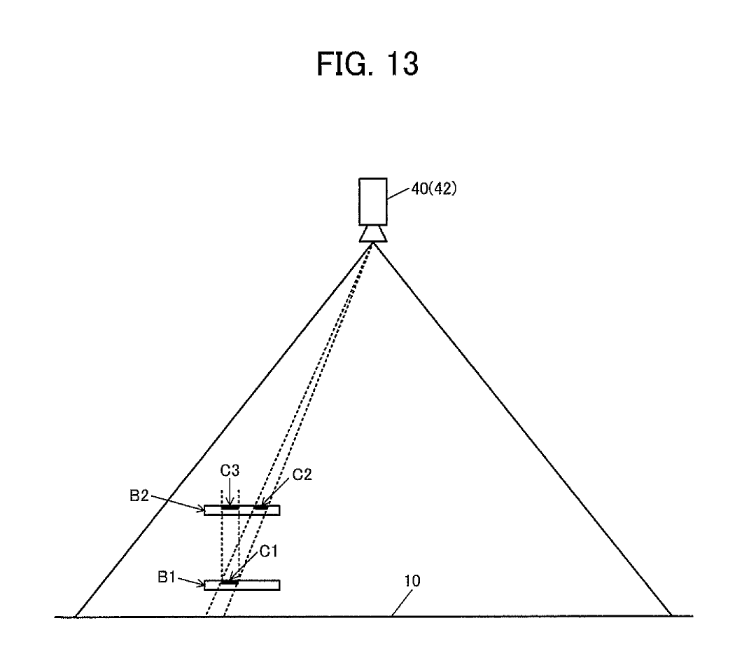

For example, in FIG. 13, B1 denotes a range of the hands 20 before being raised, B2 denotes a range of the hands 20 after being raised, C1 denotes the position and the size of the fish 14 before the hands 20 are raised, and C2 denotes the position and the size of the fish 14 after the hands 20 are raised. As is apparent from C1 and C2, the fish 14 appears to get smaller as the hands 20 move upward. To address this, a process may be performed to increase or decrease the size of the fish 14 in accordance with the height. For example, C3 represents the position and the size of the fish 14 as a result of a correction process (scaling and position adjustment described later), which is a process of enlarging the image of the fish 14 from that in C2 in this example.

As also illustrated in FIG. 13, when the hands 20 not positioned directly below the projection section 40 (42) move vertically upward, the image of the fish 14 appears to be shifting toward the position of the projection section 40 (42) from the position of the hands 20 as illustrated in C1 and C2. To correct this, a calculation may be made based on the height to perform the position adjustment process so that the image of the fish 14 is displayed without the positional relationship between the fish 14 and the hands 20 ruined as illustrated in C3.

In FIG. 13, at least one of a display position adjustment process and a size adjustment process is performed for the display object such as the fish 14 projected onto the second target, based on the position information, such as the height information, on the second target such as the hands 20 (the positional relationship between the projection sections 40 and 42 and the second target). Thus, the second projection image can be generated through an appropriate process so that the display object such as the fish 14 to be projected onto the first target is projected in accordance with the status of the second target such as the hands 20, when the first target such as the play field 10 (the game field) and the second target such as the hands 20 are determined to have satisfied the given relationship.

In FIG. 6B, the hands 20 are pulled out from the water in a location denoted with A1, and thus the fish 15 and fish 16 are determined to have been failed to be caught and thus have escaped. Specifically, the fish 15 and the fish 16 are outside the area of the predetermined range from the position of the hands 20 that have been pulled out from the water, and thus are determined to have been failed to be caught. In such a case, for example, a projection image, showing the fish 15 and the fish 16 failed to be caught swimming outward to escape from the location A1, is generated and projected onto the play field 10. Thus, the user can visually recognize that he or she has failed to catch the fish 15 and the fish 16. For an area in the periphery of the location A1 where the hands 20 have been pulled out from the water, an image of spreading ripples is generated, for example.

As illustrated in FIG. 6A, the user may move the hands 20, in a state of capturing the fish 14, to the location of the bucket 60 in FIG. 1. Thus, the hands 20 (second target) of the user approach the location of the bucket 60 (third target) so that given positional relationship is satisfied. Then, the fish 14 caught is determined to be released to the bucket 60. Then, as illustrated in FIG. 3B, the process of displaying the fish 14 caught on the display section 62 of the bucket 60 is performed. Thus, the user can experience virtual reality as if he or she is actually capturing the fish 14 and transferring the fish 14 to the bucket 60.

In the present embodiment described above, the position information on the play field 10 (first target) and the hands 20 (second target) is acquired based on the detection information (depth information) from the sensor section 50. Specifically, as described above with reference to FIG. 4 and FIG. 5, the height information on the play field 10 (height information corresponding to each segment) and the height information on the hands 20 are acquired as the position information. When the height information on the play field 10 is stored in the storage section 150 in advance as table information, only the height information (position information in a broad sense) on the hands 20 may be acquired.

Then, whether or not the play field 10 and the hands 20 have satisfied the given relationship is determined based on the position information acquired. More specifically, whether or not the given relationship has been satisfied is determined with the relative positional relationship between the play field 10 and the hands 20 obtained based on the detection information from the sensor section 50. The relative positional relationship is relationship between the hands 20 (second target) and the play field 10 (first target) in height as illustrated in FIG. 4 and FIG. 5, or the like.

When the play field 10 and the hands 20 are determined to have satisfied the given relationship, the process of changing the content of at least one of the first projection image to be projected onto the play field 10 and the second projection image to be projected onto the hands 20 is performed.

For example, as illustrated in FIG. 4, when the hands 20 are determined to be under water, based on the height information (the position information in a broad sense) between the play field 10 and the hands 20, the image of the sea water is projected onto the hands 20, and the content of the second projection image projected onto the hands 20 is changed. Furthermore, an image showing the fish 14 and the fish 15 attracted to the hands 20 is generated, and the content of the first projection image projected onto the play field 10 is changed.

When the hands 20 are determined to be pulled out from the water based on the height information on the play field 10 and the hands 20, the images of the caught fish 14 and the sea water are projected onto the hands 20, and thus the content of the second projection image projected onto the hands 20 is changed as illustrated in FIG. 6A. Alternatively, the image of the fish 14 and the fish 15 that have failed to be caught are escaping from the location A1 is generated as illustrated in FIG. 6B, and thus the content of the first projection image projected onto the play field 10 is changed.

The present embodiment described above is different from a system in which a projection image is simply projected onto a target in that a projection image reflecting position information on a target such as the play field 10 and the hands 20 can be projected onto the target. For example, relative positional relationship is utilized so that an image can move between a plurality of targets. When the positional relationship between the targets including the play field 10 and the hands 20 thus changes, projection images projected onto the targets change accordingly. Thus, a projection image reflecting movements of the user can be projected onto a target, whereby a projection system offering active user interaction, which has not been achievable in conventional systems, can be achieved. The projection system according to the present embodiment can be applied to an attraction or the like, so that an attraction that is entertaining and can be played for a long period of time without getting bored and the like can be achieved.

In the present embodiment, as illustrated in FIG. 4, positional relationship between the virtual sea surface 12 (virtual plane) set to be at a given position relative to the play field 10 (first target) and the hands 20 (second target) is obtained to determine whether or not the play field 10 and the hands 20 have satisfied given relationship. For example, when the height of the hands 20 is determined to be lower than that of the virtual sea surface 12, the hands 20 are determined to be in the water. Then, the sea water image is projected onto the hands 20 and an image showing the fish 14 and the fish 15 attracted to the hands 20 is generated. When the height of the hands 20 that have been determined to be in the water is determined to have increased to be higher than that of the virtual sea surface 12, the hands 20 are determined to have been pulled out from the water. Then, an image of the caught fish 14 to be projected onto the palms of the hands 20 is generated, or an image of the fish 15 and the fish 16 failed to be caught escaping is generated.

With a process of determining the positional relationship between the hands 20 serving as the second target and the virtual sea surface 12 set to the play field 10 instead of determining the positional relationship between the hands 20 and the play field 10 serving as the first target performed, a process of capturing a creature in the water and the like can be implemented with a simple process.

In the present embodiment, the process of changing the content of the first/second projection images is a process of making a display object appear, a process of making a display object disappear, or a process of changing an image of a display object in at least one of the first projection image and the second projection image, for example.

For example, to achieve the state illustrated in FIG. 6A, a process of making the fish 14 serving as the display object appear in the second projection image projected onto the hands 20 is performed. Meanwhile, a process of making the fish 14 disappear from the first projection image projected onto the play field 10 is performed.

To achieve the state illustrated in FIG. 6B, a process of changing an image of the fish 15 and the fish 16 serving as the display objects in the first projection image projected onto the play field 10 into an image showing the fish 15 and the fish 16 escaping from the location A1 is performed. Also in FIG. 4, a process of changing the image of the fish 14 and the fish 15 into an image showing the fish 14 and the fish 15 attracted to the hands 20 is performed when the hands 20 are determined to be in the water.

In FIG. 6A, when the fish 14 is successfully caught by scooping, a process of changing an image of the fish 14 that is a display object is performed so that the fish 14 glitters. When the caught fish 14 is moved to the location of the bucket 60, a process of changing the image of the fish 14 may be performed to display an animation showing the fish 14, above the palms of the hands 20, jumping, for example. The fish 14 thus jumped disappears from the palms of the hands 20 and is displayed on the display section 62 of the bucket 60.

Thus, when the play field 10 and the hands 20 have satisfied the given relationship (positional relationship), the user can recognize that the fish 14 has appeared or disappeared, or that the image of the fish 14 has changed, whereby a projection system offering active user interaction can be achieved.

In the present embodiment, when the play field 10 and the hands 20 are determined to have satisfied the given relationship, a process of generating the second projection image is performed so that the fish 14, serving as the projection target projected onto the play field 10 (first target), is projected onto the hands 20 (second target) as illustrated in FIG. 6A. Thus, the display object representing the fish 14 that is originally provided as the projection target projected onto the play field 10 is projected onto the hands 20. Thus, a novel projection image can be achieved.

Specifically, in the present embodiment, when the play field 10 and the hands 20 are determined to have satisfied the given relationship, the fish 14 serving as the projection target to be projected onto the play field 10 is determined to be caught by the hands 20. Then, a process of generating the second projection image is performed so that the image of the fish 14 determined to have been caught is projected onto the hands 20. Specifically, when the hands 20 are put in the water and are then determined to have moved upward through the virtual sea surface 12, the fish 14 within an area of a predetermined range from the hands 20 is determined to have been caught. Then, the second projection image is generated so that the caught fish 14 is projected onto the hands 20 as illustrated in FIG. 6A. Thus, the user can experience virtual reality to feel that he or she has actually caught the fish 14, swimming in the play field 10, with the hands 20.

In such a case, the process of generating the first projection image is performed so that the fish 15 and the fish 16, which are display objects determined to have been failed to be caught, are projected onto the play field 10 as illustrated in FIG. 6B. Thus, the user watching the first projection image on the play field 10 can not only visually recognize the caught fish 14 but can also recognize the fish 15 and the fish 16, which have been failed to be caught and thus have escaped, swimming. Thus, the user can experience improved virtual reality.

In the present embodiment, the process is performed to display the display object, which is the fish 14 determined to have been caught, at the location of the bucket 60, when the hands 20 (second target) and the bucket 60 (third target) are determined to have satisfied the given relationship. For example, when the user who has caught the fish 14 as illustrated in FIG. 6A moves the hands 20 to the location of the bucket 60 in FIG. 1, the caught fish 14 is determined to have been released to the bucket 60. Thus, the process of displaying the caught fish 14 on the display section 62 of the bucket 60 is performed. At the same time, a process of making the fish 14 projected onto the hands 20 disappear from the second projection image is performed. Thus, the user can transfer and stock the caught fish in the bucket 60, and thus can experience virtual reality simulating actual fishing. After the user has finished playing the attraction for example, an image of the fish stocked in the bucket 60 is displayed on a mobile information terminal such as a smartphone of the user. The user can bring the caught fish to his or her home. Thus, fishing or the other like attraction which has not been achievable by conventional systems can be achieved.

2.3 Marker Setting

In the configuration described above, the method according to the present embodiment is implemented with height information on the second target or the like detected. However, the present embodiment is not limited to this. For example, a process of recognizing a marker set to the second target may be performed based on the detection information from the sensor section 50. Then, position information on the second target may be acquired based on a result of the recognition process, and whether or not the first target and the second target have satisfied the given relationship may be determined based on the position information thus acquired.

For example, in FIG. 7A, the container 22 (a held object in a broad sense) serving as the second target is held by the hands 20 of the user. A marker 24 is set to the container 22 serving as the second target. In the figure, the container 22 has a shape of a hemispherical coconut, and a black marker 24 is set to be at a circular edge portion of the coconut. An image of the black circular marker 24 is captured with the camera 52 of the sensor section 50 in FIG. 4, and the process of recognizing the marker 24 is performed based on the captured image thus acquired.

Specifically, the image recognition process is performed on the captured image from the camera 52 to extract the black circle image corresponding to the marker 24. Then, for example, the center position of the black circle is obtained as the position of the container 22 serving as the second target. Specifically, the position of the container 22 in the XY plane described with reference to FIG. 4 is obtained. Then, the height information (Z) corresponding to the position (X,Y) of the container 22 thus obtained is acquired from the height information map in FIG. 5. Thus, the height of the container 22 is obtained as height information corresponding to the position of the container 22 in the XY plane, obtained by using the height information map obtained from the depth information from the depth sensor 54 of the sensor section 50.

When the height of the container 22 serving as the second target is determined to be lower than the virtual sea surface 12, the container 22 is determined to be in the water, and the image of the sea water is projected onto the container 22, as in FIG. 4. Furthermore, an image showing the fish 14 and the fish 15 attracted to the container 22 is generated. Then, when the height of the container 22 is determined to be higher than that of the virtual sea surface 12, the container 12 is determined to have been pulled out from the water. Then, whether or not fish is caught is determined. When the fish is determined to have been caught, the image of the fish 14 successfully caught to be projected onto the container 22 is generated as in FIG. 6A. Furthermore, the image showing the fish 15 and the fish 16 failed to be caught escaping from the location A1 is generated as in FIG. 6B.

For example, a position of the hands 20 may be obtained by detecting a color of the hands 20 (a color close to the skin color) from the captured image obtained with the camera 52 of the sensor section 50. Unfortunately, the position of the hands 20 is difficult to stably and appropriately detect with this method. When the fish 14 is caught as in FIG. 6A, the image of the fish 14 and the like might be affected by wrinkles and the color of the hands 20, to be difficult to clearly project onto the hands 20.

In view of this, in the method illustrated in FIG. 7A, the position of the container 22 is detected based on a result of the process of recognizing the marker 24 set to the container 22. Thus, the position of the container 22, serving as the second target, can be stably and appropriately detected, compared with the method of detecting the position of the hands 20 based on the color or the like of the hands 20. The projection surface and the like of the container 22 are appropriately set so that there is an advantage that the images of the caught fish, the sea water, and the like can be clearly projected onto the projection surface of the container 22.

As illustrated in FIG. 7B, pattern recognition may be performed on the marker 24 so that a process of changing the type of fish attracted to the user can be performed based on a result of the pattern recognition.

For example, the pattern of the marker 24 may be that illustrated on the left side of FIG. 7B. In such a case, when the container 22 is determined to be in the water, the fish 15 corresponding to the pattern is attracted to the container 22. The pattern of the marker 24 may be that illustrated on the right side of FIG. 7B. In such a case, the fish 16 corresponding to the pattern is attracted to the container 22.

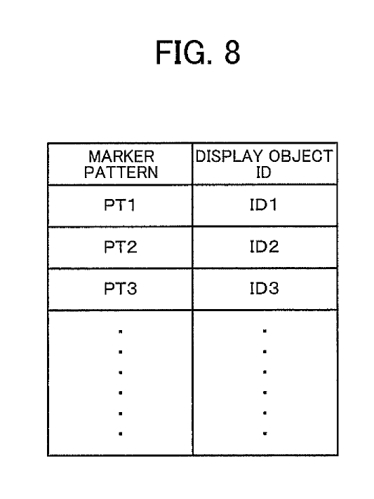

Specifically, marker pattern information (table) as illustrated in FIG. 8, in which marker patterns are associated with fish display object IDs, is prepared. This marker pattern information is stored in the marker pattern storage section 154 in FIG. 2. Then, whether or not any of the marker patterns in FIG. 8 is detected is determined through an image recognition process on the captured image from the camera 52 of the sensor section 50. When the container 22 is determined to be in the water, an image showing fish corresponding to the detected marker patter appeared and attracted to the container 22 is generated.

Thus, the type of fish that can be easily caught by the user can be changed in accordance with the pattern of the marker 24 of the container 22 of the user. Thus, an attraction that can be played for a long period of time without getting bored and the like can be achieved.

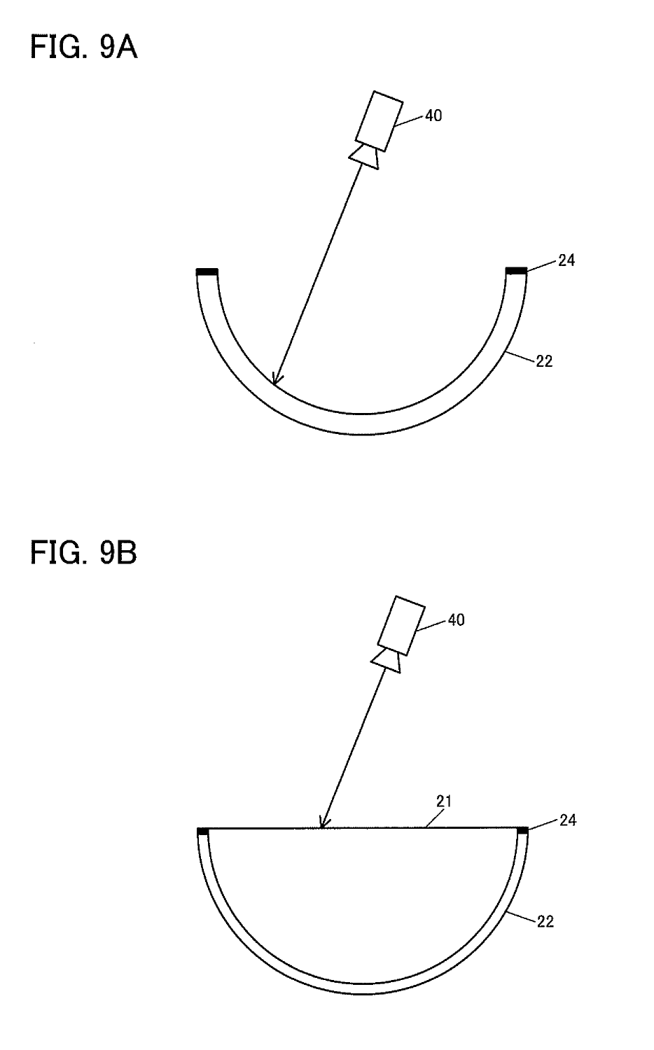

Various methods may be employed to project a projection image (second projection image) onto the container 22 (held object). For example, in FIG. 9A, the projection section 40 projects a projection image onto an inner surface of the hemispherical container 22.

In FIG. 9B, a planer projection surface 21 is set to be in an upper portion of the container 22. The projection section 40 projects a projection image onto this planer projection surface 21. Thus, for example, a projection image with small distortion can be easily projected onto the container 22. For example, with the method illustrated in FIG. 9A, distortion correction needs to be performed based on the inner surface shape of the hemispherical container 22, the position of the projector, and the viewpoint position of the user to project a projection image with small distortion. For example, the distortion correction is performed by using a formula and the like representing the inner surface shape of the hemispherical container 22.

With the method illustrated in FIG. 9B, a projection image with small distortion can be projected onto the container 22 without such distortion correction. When the user shows fish he or she has caught to another user or observer, appropriate distortion correction cannot be simultaneously performed for a plurality of viewpoint positions. Still, the method illustrated in FIG. 9B involves less unevenness of the container, and thus, enables the users to equally see the fish from different viewpoints.

The method using a marker is not limited to those described with reference to FIG. 7A and FIG. 7B. For example, a two-dimensional code that is invisible to a player may be printed, applied, or bonded onto a bottom or an inner surface of the container 22 with infrared ink, a retroreflective material, or the like, and an image of the code may be captured with an infrared camera.

FIG. 10 illustrates an alternative example where a plurality of bait items 26 are prepared. The bait items 26 are each provided with an infrared LED marker, for example.

When the user places the bait item 26 on the palms of the hands 20, the position of the bait item 26 (hands 20) is recognized through image recognition, using the camera 52 of the sensor section 50, on a light emitting pattern of the infrared LED marker. Then, an image showing fish attracted to the bait item 26 is generated. For example, an animation showing the fish nudging the bait item 26 is displayed with the bait item 26 vibrating. Specifically, the bait item 26 is vibrated by a vibration mechanism provided to the bait item 26, and the resultant vibration is transmitted to the hands 20 of the user.

When the fish is successfully scooped up, the caught fish flaps on the palms of the hands 20, and the resultant vibration is transmitted to the hands 20 of the user. For example, the bait item 26 is vibrated, and the resultant vibration is transmitted to the hands 20 of the user. Thus, the user can experience virtual reality to feel as if he or she has actually scooped up and caught real fish.

In this configuration, the plurality of bait items 26 are prepared as illustrated in FIG. 10, so that different types of fish can be attracted by different types of bait items 26. For example, the infrared LED marker of the bait items 26 emits light with different light emitting patterns. Thus, the type of the light emitting pattern is determined through image recognition, so that when the hands of the users, holding the bait items 26, are moved downward through virtual sea surface 12 (virtual water surface), the bait item 26 attracts fish corresponding to the type of the pattern of the light emitted from the bait item 26. Thus, different types of fish are attracted to different users, whereby the attraction can offer a wider selection of entertainment.

The infrared LED marker is used for each of the bait items 26 instead of a visible LED to be easier to be recognized than the visible LED in a visible light beam emitted by the projector. Note that the visible LED may be used, a piece of paper or the like with the marker pattern printed thereon may be used, and the marker pattern may be directly printed on each of the bait items 26 as long as the recognition can be easily performed.

A near field communication (NFC) chip may be embedded in each of the bait item 26, instead of the infrared LED marker. Thus, the fish may be attracted to the bait item 26 with a communication signal output from the NFC chip serving as the marker.

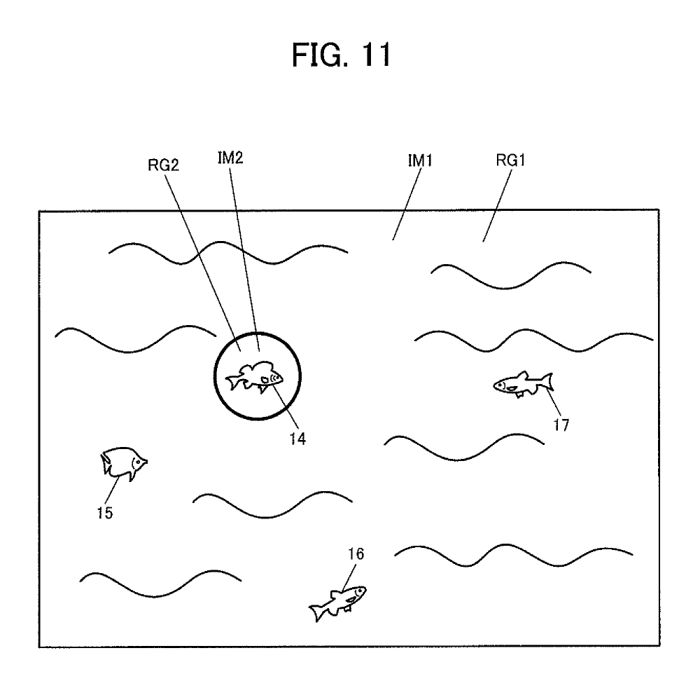

In the present embodiment, as illustrated in FIG. 11, a second projection area RG2, onto which the second projection image is projected, is obtained based on the marker provided to the container 22 or the bait item 26. Then, a process of generating a second projection image IM2, projected onto the second projection area RG2, may be performed.

For example, in FIG. 11, the first projection image projected onto the first target such as the play field 10 is rendered on a first projection area RG1, on an image rendering VRAM. The second projection image projected onto the second target such as the container 22 or the hands 20 is rendered on the second projection area RG2. The projection sections 40 and 42 in FIG. 1 cooperate to project the images on the VRAM onto the play field 10 and the container 22 or the hands 20.

Specifically, a location (address) of the second projection area RG2 on the VRAM is identified based on a result of recognizing the marker 24, and the second projection image IM2 projected onto the second target such as the container 22 or the hands 20 is rendered on the second projection area RG2 thus identified. When the fish 14 is determined to be caught as illustrated in FIG. 6A for example, the second projection image IM2, showing the fish 14 successfully caught appearing and glittering as illustrated in FIG. 11, is generated and rendered on the second projection area RG2. Furthermore, a first projection image IM1, showing the fish 15 and the fish 16 that have been failed to be caught escaping from the location A1 of the hands 20 as illustrated in FIG. 6B, is generated and rendered on the first projection area RG1.

When the user who has caught the fish 14 moves the container 22 or the hands 20, the position of the second projection area RG2 changes accordingly. When the container 22 or the hands 20 move to the location of the bucket 60 and thus the fish 14 is determined to have been released to the bucket 60, the second projection image IM2 showing the fish 14 thus released disappearing is generated and rendered on the second projection area RG2.

In this manner, a process of changing the content of the first and the second projection images IM1 and IM2 involving a rendering process as illustrated in FIG. 11 can be implemented with a simple rendering process.

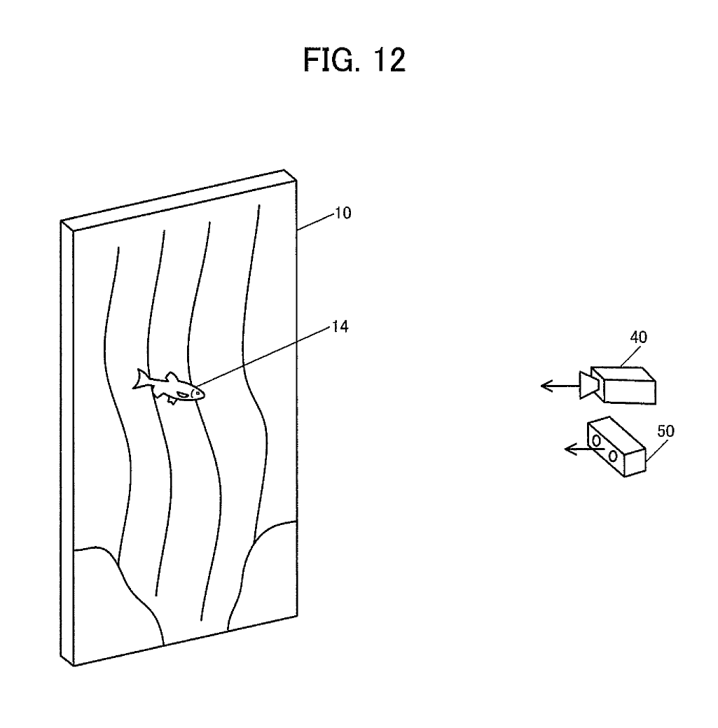

In the description above, the play field 10 is a field such as a sand pit with the projection surface approximately in parallel with the horizontal plane (ground surface). However, the present embodiment is not limited to this. For example, as illustrated in FIG. 12, the play field 10 with a projection surface orthogonal to (crossing) the horizontal plane may be employed. This play field 10 simulates a waterfall, enabling the user to catch the fish 14 with his or her hand or a landing net provided with the marker for example. The projection section 40 and the sensor section 50 are provided on a lateral side of the play field 10. The projection section 40 projects an image of the waterfall onto to the play field 10. The sensor section 50 detects height information in a direction along the water surface so that whether or not the hand or the landing net of the user has moved through the virtual water surface or whether or not the fish 14 is caught can be determined. Furthermore, a process of providing a visual effect of water splashing at the portion of the water surface where the hand or the landing net has entered is provided for example.

3. Process Details

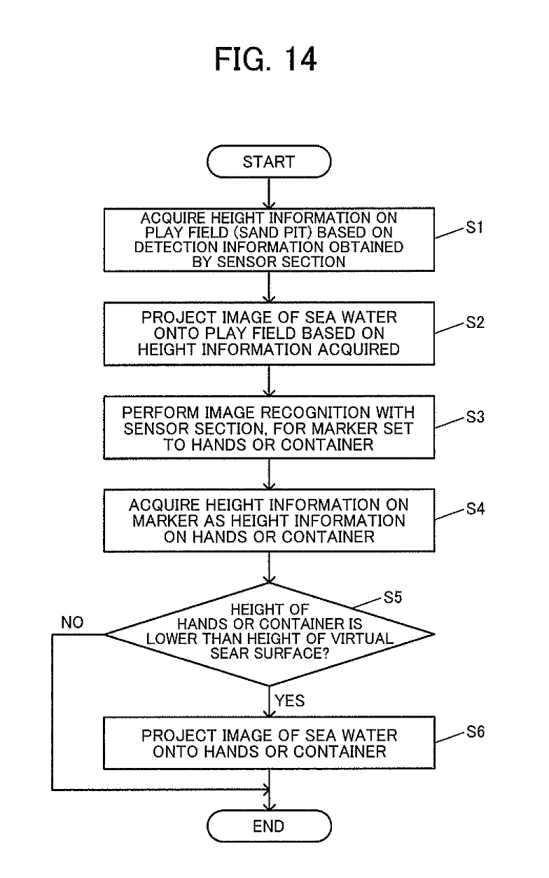

Next, a detailed example of a process according to the present embodiment is described with reference to a flowchart in FIG. 14.

First of all, height information on the play field 10 is acquired based on the detection information from the sensor section 50 as described above with reference to FIG. 4 and FIG. 5 (step S1). Then, the sea water image is projected onto the play field 10 based on the height information acquired (step S2). For example, the sea water image is projected in such a manner that a recessed portion of the sand pit serving as the play field 10 is provided with a sea water puddle.

Next, the sensor section 50 performs image recognition for the marker set to the hands or the container, and acquires height information on the marker as the height information on the hands or the container (steps S3 and S4). For example, the position of the marker (in the XY plane) is obtained through the image recognition on the captured image obtained with the camera 52 of the sensor section 50, and the height information on the marker is acquired from the height information map, illustrated in FIG. 5, based on the position of the marker.

Next, whether or not the height of the hands or the container is lower than the height of the virtual sea surface is determined (step S5). If the height of the hands or the container is lower than the height of the virtual sea surface, the sea water image is projected onto the hands or the container (step S6).

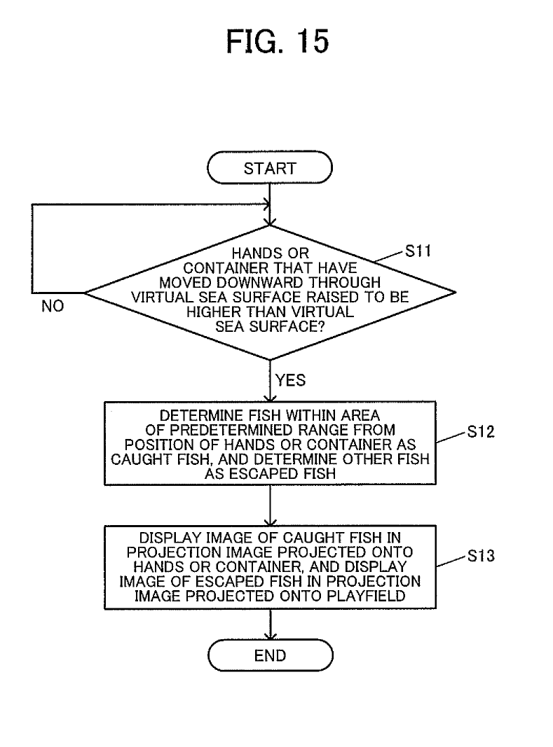

FIG. 15 is a flowchart illustrating a detailed example of a process for determining whether or not fish is caught, and the like.

First of all, as illustrated in FIG. 4, whether or not the hands or the container that have been moved downward through the virtual sea surface is pulled up to be higher than the virtual sea surface is determined (step S11). When the hands or the container is pulled up to be higher than the virtual sea surface, fish within an area of a predetermined range from the position of the hands or the container in this event is determined to have been caught, and other fish is determined to have escaped (step S12). Then, a process is performed to display an image of the caught fish in the projection image projected onto the hands or the container, and the image of the escaped fish is displayed in the projection image projected onto the play field 10 (step S13). For example, an image showing the caught fish 14 is generated as the second projection image IM2 projected onto the second projection area RG2 in FIG. 11, and an image showing the fish 15, the fish 16, and fish 17 that have escaped is generated as the first projection image IM1 to be projected onto the first projection area RG1.

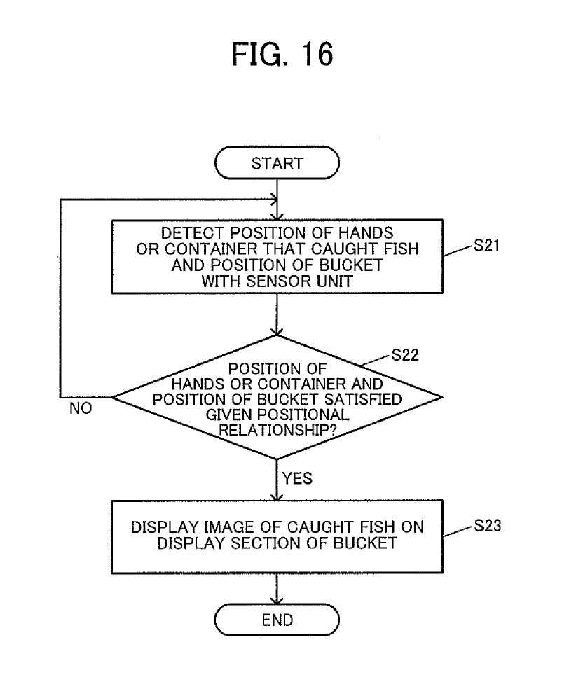

FIG. 16 is a flowchart illustrating an example of a process of determining whether or not fish is released or the like in detail.

First of all, the position of the hands or the container that has caught the fish and the position of the bucket are detected with the sensor section 50 (step S21). Then, whether or not the position of the hands or the container and the position of the bucket have satisfied the given positional relationship is determined (step S22). For example, whether or not the position of the hands or the container overlaps with the location of the bucket is determined. Then, when the given positional relationship has been satisfied, the caught fish is determined to be released to the bucket, and the image of the fish is displayed on the display section of the bucket (step S23).

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention. For example, each the terms (such as the play field, the hands/container, the held object, and the virtual sea surface) that are at least once written together with a term or a wider sense or an alternative term (such as the first target object, the second target object, and the virtual plane) in the specification or the figures, can be replaced with the alternative term at any part of the specification or the figures. The method for projecting a projection image, the method for determining the relationship between the first and the second target objects, the method for determining whether or not the target has been caught or released are not limited to those described in the embodiment, and the scope of the present invention further includes methods equivalent to these. The method according to the present invention can be applied to various attractions and game systems.

What is claimed is:

1. A projection system comprising:
a projector projecting a projection image; and
a processor acquiring position information on at least one of first and second targets based on detection information obtained by a sensor, and performing a process of generating the projection image,
the processor performing, when the first target and the second target are determined to have satisfied given relationship based on the position information acquired, a process of changing a content of at least one of a first projection image to be projected onto the first target and a second projection image to be projected onto the second target, and
the processor obtaining positional relationship between the second target and a virtual plane set to be at a given position relative to the first target to determine whether or not the first target and the second target have satisfied the given relationship.

2. The projection system as defined in claim 1,
the processor performing, when the first target and the second target are determined to have satisfied the given relationship, at least one of a process of making a display object appear, a process of making a display object disappear, and a process of changing an image of a display object in at least one of the first projection image to be projected onto the first target and the second projection image to be projected onto the second target.

3. The projection system as defined in claim 1,
the processor performing a process of generating, when the first target and the second target are determined to have satisfied the given relationship, the second projection image in such a manner that a display object serving as a projection target to be projected onto the first target is projected onto the second target.

4. The projection system as defined in claim 3,
the processor performing display control on the display object based on relationship between the display object to be projected onto the second target and the second target.

5. The projection system as defined in claim 3,
the processor performing, when the first target and the second target have satisfied the given relationship, a calculation process based on a process rule, and performing display control on the display object in such a manner that the display object determined to be projected onto the second target as a result of the calculation process is projected onto the second target.

6. The projection system as defined in claim 3,
the processor performing, when relationship between the first target and the second target changes from the given relationship, display control on the display object in accordance with change in the relationship between the first target and the second target.

7. The projection system as defined in claim 6,
the processor performing, when the relationship between the first target and the second target changes, a calculation process based on a process rule and performing display control on the display object in such a manner that the display object determined to be projected onto the second target as a result of the calculation process is projected onto the second target.

8. The projection system as defined in claim 6,
the processor performing, when the relationship between the first target and the second target changes, a calculation process based on a process rule and performing display control on the display object in such a manner that the display object determined not to be projected onto the second target as a result of the calculation process is projected onto the first target.

9. The projection system as defined in claim 3,
the processor performing, when the second target and a third target are determined to have satisfied given relationship, a process of displaying the display object onto the third target.

10. The projection system as defined in claim 1,
the processor obtaining relative positional relationship between the first target and the second target based on the detection information obtained by the sensor to determine whether or not the first target and the second target have satisfied the given relationship.

11. The projection system as defined in claim 10,
the relative positional relationship being relationship between the first target and the second target in height.

12. The projection system as defined in claim 1,
the processor performing a recognition process on a marker set to the second target based on the detection information obtained by the sensor, acquiring position information on the second target based on a result of the recognition process, and determining whether or not the first target and the second target have satisfied the given relationship based on the position information acquired.

13. The projection system as defined in claim 12,
the processor obtaining, based on the marker, a second projection area onto which the second projection image is projected and performing a process of generating the second projection image to be projected onto the second projection area.

14. The projection system as defined in claim 1,
the second target being a body part of a user or a held object held by the user.

15. A projection system comprising:
a projector projecting a projection image onto a play field serving as a first target: and
a processor performing a process of generating the projection image,
the processor generating the projection image for displaying an image of a water surface onto a virtual plane set to be at a given position relative to the play field and for displaying an image of a creature,
the projector projecting the projection image for displaying the image of the water surface and the image of the creature onto the play field,
the processor performing, based on position information on a second target, a process of changing a content of at least one of a first projection image to be projected onto the play field serving as the first target and a second projection image to be projected onto the second target.

16. The projection system as defined in claim 15,
the processor performing at least one of a process of making a display object appear, a process of making a display object disappear, and a process of changing an image of a display object in at least one of the first projection image to be projected onto the play field and the second projection image to be projected onto the second target.

17. The projection system as defined claim 15,
the processor performing a recognition process for a marker set to the second target, acquiring position information on the second target based on a result of the recognition process, and performing a process of changing a content of at least one of the first projection image and the second projection image based on the position information acquired.

18. The projection system as defined in claim 15,
the second target being a body part of a user or a held object held by the user.

19. The projection system as defined in claim 15,
the processor performing, when the second target and the play field serving as the first target are determined to have satisfied given relationship based on the position information on the second target, a process of changing a content of at least one of the first projection image and the second projection image.

20. The projection system as defined in claim 15,
the processor acquiring the position information on the second target based on the detection information obtained by the sensor.

21. The projection system as defined in claim 15,
the projector projecting the projection image for displaying the image of the water surface and the image of the creature onto the play field by projection mapping.

22. The projection system as defined in claim 21,
the play field being a sand pit.

23. The projection system as defined in claim 15,
the processor generating the projection image for displaying animation of the water surface and the creature.

24. The projection system as defined in claim 15,
the projector being provided above the play field.
